(19) United States
(12) Patent Application Publication
(10) Pub. No.: US 2014/0260948 A1
(43) Pub. Date: Sep. 18, 2014

(54) HYDRAULIC ACTUATOR FOR A COMPRESSED AIR ENERGY STORAGE SYSTEM

(71) Applicant: General Compression, Inc., Newton, MA (US)

(72) Inventors: Yuriy Cherepashenets, Waltham, MA (US); German Lakov, Brookline, MA (US); Ryan Heinbuch, Plymouth, MI (US)

(21) Appl. No.: 14/212,983

(22) Filed: Mar. 14, 2014

Related U.S. Application Data
(60) Provisional application No. 61/792,872, filed on Mar. 15, 2013.
(60) Provisional application No. 61/792,880, filed on Mar. 15, 2013.

(51) Int. Cl. F15B 15/02

(52) U.S. Cl. CPC F15B 15/02
USPC 91/358 R; 91/471

(57) ABSTRACT

A hydraulic actuator adapted to be coupled to one or more pistons of a compressed air energy storage (CAES) system includes a housing forming a plurality of aligned bores, with a shaft disposed therein for reciprocating movement. For a three bore configuration, the shaft has three pistons subdividing the three bores into six pressure chambers. Four valves fluidically connected to the six chambers selectively provide pressurized hydraulic fluid, permitting three levels of hydraulic shaft force for each direction of shaft motion.

### CROSS-REFERENCE TO RELATED APPLICATION

This application claims priority to and the benefit of U.S. Provisional Patent Application No. 61/792,872, filed Mar. 15, 2013, and entitled “Hydraulic Actuator for a Compressed Air Energy Storage System,” and U.S. Provisional Patent Application No. 61/792,880, filed Mar. 15, 2013, and entitled “Horizontal Actuation Compressed Air Energy Storage System,” the entireties of which are hereby incorporated by reference herein.

### FIELD OF THE INVENTION

The invention relates generally to a hydraulic actuator and, more particularly, to a hydraulic actuator operable in a number of actuation states that is greater than the number of valves associated with the actuator piping assembly.

### BACKGROUND

A compressed air energy storage (CAES) system is a type of system for storing energy in the form of compressed gas (e.g., air). CAES systems may be used to store energy in the form of compressed air when electricity demand is low, typically during the night, and then to release the energy when demand is high, typically during the day. A CAES system may be operated by a hydraulic actuator, which drives a piston to compress gas in a pressure vessel chamber. Existing hydraulic actuators, however, are often structurally complex and require large valves and piping due to the high fluid flow rates required for operation. Further, such actuators suffer from the problems associated with tidal volume and the compression and decompression of large hydraulic chamber volumes in effecting actuation. What is needed then, is a hydraulic actuator usable in a CAES system that overcomes the deficiencies of existing actuators.

### SUMMARY

Various embodiments of a hydraulic actuator and methods for operating the same are described. In one aspect, a hydraulic actuator adapted to be coupled to a piston of a CAES system includes a housing forming three aligned bores and a shaft disposed in the housing for reciprocating movement. The shaft includes three or more pistons disposed in the three bores, thereby dividing the three bores into a plurality of pressure chambers. Further, the shaft is moveable relative to the housing by pressurizing at least one of the pressure chambers with hydraulic fluid.

In one embodiment, the housing includes a plurality of cylinders forming the bores, and corresponding dividers disposed between the cylinders. There can be two or more dividers, which can form a fluidic seal with the shaft. The pistons and the dividers can form six or more pressure chambers.

In another embodiment, the shaft further includes a rod, and the pistons are attached to the rod and/or forged on the rod. The rod can have a varying outer diameter, at least two of the bores can have different inner diameters, and/or at least two of the pistons can have different outer diameters.

In a further implementation, the actuator includes a plurality of fluidic valves fluidically coupled to the pressure chambers. The valves can be adapted to be independently operable to pressurize a combination of the pressure chambers to control direction of movement and force of the shaft. There can be four or more valves to pressurize selectively six pressure chambers.

In yet another embodiment, the shaft is adapted to be coupled at at least one of a proximal end and a distal end thereof to the CAES piston disposed in a separate housing. The shaft can be adapted to be coupled at the proximal end to a first CAES piston disposed in a first separate housing and at the distal end to a second CAES piston disposed in a second separate housing.

In another aspect, a method for operating a hydraulic actuator includes providing a hydraulic actuator having a housing forming three aligned bores and a shaft disposed in the housing for reciprocating movement. The shaft includes three or more pistons disposed in the three bores, thereby dividing the three bores into a plurality of pressure chambers. The shaft is moved relative to the housing by pressurizing at least one of the pressure chambers with hydraulic fluid.

In one embodiment, the housing includes a plurality of cylinders forming the bores, and corresponding dividers disposed between the cylinders. There can be two or more dividers, which can form a fluidic seal with the shaft. The pistons and the dividers can form six or more pressure chambers.

In another embodiment, the actuator includes a plurality of fluidic valves fluidically coupled to the pressure chambers. At least one of the valves can be operated to pressurize a combination of the pressure chambers to control direction of movement and force of the shaft. There can be four or more valves to pressurize selectively six pressure chambers.

In yet another embodiment, the shaft is coupled at at least one of a proximal end and a distal end thereof to a piston of a CAES system disposed in a separate housing. The shaft can be coupled at the proximal end to a first piston of a CAES system disposed in a first separate housing and at the distal end to a second piston of a CAES system disposed in a second separate housing.

Other aspects and advantages of the invention will become apparent from the following drawings, detailed description, and claims, all of which illustrate the principles of the invention, by way of example only.

### BRIEF DESCRIPTION OF THE DRAWINGS

A more complete appreciation of the invention and many attendant advantages thereof will be readily obtained as the same becomes better understood by reference to the following detailed description, when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1 is a diagram of an example energy storage and delivery system including a conversion subsystem usable with the present invention.

FIG. 2 is a diagram of a hydraulic actuator according to an embodiment of the invention.

FIG. 3 is a schematic perspective view of the hydraulic actuator of FIG. 2,

FIG. 4 is a schematic perspective view of a cross-section of a piston and shaft of a hydraulic actuator according to an embodiment of the invention.

FIG. 5 is a diagram of a load path of forces on the piston and shaft of FIG. 4.

FIG. 6 is a diagram of a valving configuration for a hydraulic actuator according to an embodiment of the invention.

FIG. 7 is a table of chamber pressurization states for the valving configuration of FIG. 6.

FIGS. 8A-8F are diagrams of valve states and fluid flows for actuator gears corresponding to the table of FIG. 7.

FIGS. 9A and 9B are diagrams of alternative mounting configurations for a hydraulic actuator.

FIG. 10 is a schematic perspective view of a CAES system including two hydraulic actuators,

### DETAILED DESCRIPTION

Described herein in various embodiments is a hydraulic actuator suitable for use in a compressed air energy storage (CAES) system, such as those described in U.S. Patent Application No. 61/792,880, filed Mar. 15, 2013, and entitled “Horizontal Actuation Compressed Air Energy Storage System” (the “Horizontal CAES application”), the entirety of which is incorporated by reference herein. The present actuator may also be incorporated in CAES systems such as those described in U.S. patent application Ser. No. 13/347,144, filed Jan. 10, 2012, and entitled “Compressor and/or Expander Device”; U.S. Pat. No. 8,522,538, issued Sep. 3, 2013, and entitled “Systems and Methods for Compressing and/or Expanding a Gas Utilizing a Bi-directional Piston and Hydraulic Actuator”; and U.S. Pat. No. 8,161,741, issued Apr. 24, 2012, and entitled “System and Methods for Optimizing Efficiency of a Hydraulically Actuated System,” the entireties of which are hereby incorporated by reference herein. Further, the present invention may be used in hydraulic, pneumatic, or other systems that would benefit from an actuator providing varying actuation forces in multiple directions.

CAES systems may be used for energy storage and generation, as shown in FIG. 1. A power source 102 (e.g., a wind farm including a plurality of wind turbines) may be used to harvest and convert wind or other types of energy to electric power for delivery to a power routing subsystem 110 and conversion subsystem 112. It is to be appreciated that the system 100 may be used with electric sources other than wind farms, such as, for example, with the electric power grid, or solar power sources. In some embodiments, the power source 102 is collocated with the CAES system. It should be noted, however, that the power source 102 may be distant from the CAES system, with power generated by the power source 102 being directed to the CAES system via a power grid or other means of transmission. The power routing subsystem 110 directs electrical power from the power source 102 to the power grid 124 or conversion subsystem 112, as well as between the power grid 124 and the conversion subsystem 112.

The conversion subsystem 112 converts the input electrical power from the wind turbines or other sources into compressed gas, which can be expanded by the conversion subsystem 112 at a later time period to access the energy previously stored. The conversion subsystem 112 may include an interconnected (in series or parallel) motor/generator, hydraulic pump/motor, hydraulic actuator and compressor/expander to assist in the energy conversion process. At a subsequent time, for example, when there is a relatively high demand for power on the power grid, or when power prices are high, compressed gas may be communicated from the storage subsystem 122 and expanded through a compressor/expander device in the conversion subsystem 112, Expansion of the compressed gas drives a generator to produce electric power for delivery to the power grid 124. In some embodiments, multiple conversion systems may operate in parallel to allow the CAES system to convert larger amounts of energy over fixed periods of time.

One or more working pistons of a CAES system may be driven by or drive one or more of the hydraulic actuators described herein. The loads applied to the working piston(s) can be varied during a given cycle of the CAES system. For example, in a hydraulic actuator, by applying hydraulic fluid pressure to different hydraulic pistons and/or different surfaces of the piston(s) within the hydraulic actuator(s), the ratio of the net working surface area of the hydraulic actuator to the working surface area of a working piston acting on the gas and/or liquid in a working chamber of the CAES system can be varied and, therefore, the ratio of the hydraulic fluid pressure to the gas and/or fluid pressure in the working chamber of the CAES system can be varied during a given cycle or stroke of the system. In addition, the number of working pistons, working chambers and actuators can be varied, as well as the number of piston area ratio changes within a given cycle.

The hydraulic actuator may be coupled to a hydraulic pump having operating ranges that can vary as a function of, for example, flow rate and pressure, among other parameters. Systems and methods of operating the hydraulic pumps/motors to allow them to function at an optimal efficiency throughout the stroke or cycle of the gas compression and/or expansion system are described in U.S. Pat. No. 8,161,741, issued Apr. 24, 2012, and entitled “Systems and Methods for Optimizing Efficiency of a Hydraulically Actuated System,” the entirety of which is hereby incorporated by reference herein.

The structure of the hydraulic actuator described herein provides a number of advantages over existing devices. For example, the uncomplicated design results in a high confidence level that simulated power levels will be achieved. In some embodiments, only four two-way, low power consumption, hydraulic valves are required to provide six gears (as discussed below). Further, the valves and piping may be of relatively small size, compared to those of actuators used in existing CAES systems, due to relatively low fluid volumetric flow rates. Increased efficiency results from the low flow velocities, as well as the reduced compression and decompression of large chamber volumes during gear progression. Moreover, in some embodiments, tidal volume and the problems associated therewith are reduced or avoided, because the actuator incorporates a closed-loop hydraulic circuit enabled by the flow of hydraulic fluid among the chambers of the actuator housing. The force produced by the actuator may also be split between two end connections at opposite ends of the actuator.

Referring now to FIG. 2 and FIG. 3, in one embodiment, the hydraulic actuator 200 includes a longitudinal housing 205 having three axially-aligned double-acting cylinders 210a-210c and associated valving, which enables three “gears” in each direction of actuation. As used herein, a “gear” is defined by a ratio of the effective working ram area to the effective hydraulic ram area of the pressurized cylinder(s). The three coaxial cylinders 210a-210c form three bores 220a-220c. Two dividers 215a, 215b are interdisposed between the cylinders 210a-210c and a reciprocating shaft 250 having three pistons 230a-230c is disposed in the housing 205. The dividers 215a, 215b form a fluidic seal with the shaft 250 and, with the pistons 230a-230c, form six pressure chambers 260a-260f within the housing 205. Four valves 270a-270d and associated spools 272a-272d, manifolds 274a, 274b, and piping 276a-276d fluidically and selectively couple the chambers 260a-260f of the actuator 200 to a closed pressure source and drain system. The valves 270a-270d may be independently operated to pressurize one or more of the six pressure chambers 260a-260f in various combinations, thereby controlling the movement and force of the shaft 250. In one embodiment, three combinations of the chambers 260a-260f are pressurized to drive the shaft 250 in a first direction, and three different combinations of the chambers 260a-260f are pressurized to drive the shaft 250 in a second direction, opposite the first direction.

The valves 270a-270d are disposed on spools 272a, 272c that are coupled to the cylinders 210a-210c of the hydraulic actuator 200. Positioning the valves 270a-270d at the cylinders 210a-210c, rather than on one or more manifolds 274a, 274b, provides for simpler construction techniques. Because the valve connections 270a-270d are disposed on a greater number of components of lower mass (rather than a single component of higher mass), there is less risk in material quality and manufacturing error. Further, the valves 270a-270d and piping assembly 276a-276d can be mounted to the cylinders 210a-210c at a manufacturing facility, rather than assembled in the field, providing better quality control and a cleaner assembly environment.

The valving configuration can include one or more types of valves of any suitable construction. In one embodiment, a commercially available two-way valve can be used, such as a 100 mm elbow plug or poppet valve having a fast actuation time (less than 50 ms) and a low pressure drop, considering the 90-degree flow angle. Using flow coefficient values and measured test data, this particular valve is calculated to have a pressure drop of 0.26 bar at a flow rate of 6000 L/m.

As used herein the term “piston” is not limited to pistons of circular cross-section, but can include pistons with across-section of a triangular, rectangular, or other multi-sided shape or of a non-circular contoured shape (e.g., oval). In some embodiments, some or all of the pistons 230a-230c have different outer diameters. In other embodiments, the rod of the shaft 250 has a varying outer diameter. In further embodiments, some or all of the bores 220a-220c have varying inner diameters. Variations in the diameters of the actuator components may result in different net forces produced by the actuator 200 as the various chambers are pressurized, due to the net area being pressurized. The interior and/or exterior walls of the cylinders 210a-210c may conform to the shape of the pistons 230a-230c, and/or may include sealing elements to maintain a seal between the pistons 230a-230c and the interior walls of the cylinders 210a-210c. The pistons 230a-230c may be constructed of any suitable material.

The pistons 230a-230c may be forged to the rod of the shaft 250, and/or attached to the rod using, e.g., various clamping mechanisms. For example, referring to FIG. 4 and FIG. 5, a piston 410 can be clamped to a rod 415 using a diamond ring 420. The diamond ring 420 may include multiple portions; for example, the ring 420 may be split into two half-circle pieces to facilitate assembly on the rod 415, As shown, the diamond ring 410 can be disposed in a circumferential groove 425 on an outer surface of the rod 415 such that the facets of the inner surface of the ring form a match fit with the facets of the groove 425. Likewise, the piston 410 can have a circumferential groove 430 on an inner surface of the piston 410 that forms a match fit with the facets of the outer surface of the ring 420. The piston 410 can be constructed of one or more pieces; for example, the piston 410 can include two annular rings 412a, 412b clamped together with bolts, rivets, or other fasteners. Other piston and clamping structures are contemplated.

Use of the diamond ring 420 clamping structure results in forces on the rod 415 and piston 410 generally along the load paths shown in FIG. 5. When longitudinal force 470 is applied in direction A to the rod 415, component 460 of the longitudinal force 470 is directed to the diamond ring 420 and piston 410. Similarly, when longitudinal force 472 is applied in direction B to the rod 415, component 462 of the longitudinal force 472 is directed to the diamond ring 420 and piston 410.

FIG. 6 depicts one implementation of a valving configuration 600 of the hydraulic actuator 200. The six chambers of the actuator 200 (labeled A-F) may be pressurized in different six combinations by toggling the four valves 270a-270d respectively associated with manifolds 274a and 274b. Three of the six combinations provide differing actuator forces in direction 610, with the other three combinations providing differing actuator forces in direction 620.

FIGS. 7 and 8A-8F, in combination with FIG. 6, illustrate the gear progression process pictorially. Specifically, FIG. 7 depicts a diagram of actuator 200 with chambers A-F corresponding to the chambers having the same labels in FIG. 6. The table below the pressure chamber diagram specifies the individual chambers of the actuator 200 that are pressurized to produce the six gears (i.e., C, AC, ACE, ABDEF, BDEF, and BDF). FIGS. 8A-8F illustrate the valve states and hydraulic fluid flows corresponding to the six gears. Reference is made to these figures in the following description.

In one implementation, actuator 200 can operate in direction 610 in three different gears. Gear 1 (C) (shown in FIG. 8A) is achieved by providing high pressure fluid via manifold 247a, which results in the high pressure fluid directly entering into chamber C. Manifold 247b acts as a low pressure drain. Valves 270a and 270c are set to a closed state and valves 270b and 270d are set to an open state, resulting in chamber C being pressurized from the high pressure fluid from manifold 247a, and chambers A, B, E, and F being unpressurized or at a low pressure. The net result in this gear is area C.

Starting from gear 1 (C), gear 2 (AC)(shown in FIG. 5B) is achieved by opening valve 270a and simultaneously (or with a timing offset) closing valve 270b. Of note, the valve states can be changed while a hydraulic pump is providing 100% of the flow. By changing the states of valve 270a and 270b, high pressure fluid from manifold 247a enters and pressurizes chamber A. Valve 270c remains in a closed state, and valve 270d remains in an open state. Thus, in gear 2 (AC), chambers A and C are pressurized from the high pressure fluid and chambers B, D, E, and F are unpressurized or at a low pressure. The net result in this gear is area A+area C.

Starting from gear 2 (AC), gear 3 (ACE) (shown in FIG. 8C) is achieved by performing the same valve state changes as described with respect to the gear 2 (AC), but instead with respect to valve 270c and valve 270d. In other words, valve 270c is changed to an open state while valve 270d is changed simultaneously (or with a timing offset) to a closed state. As a result, high pressure fluid from manifold 247a enters and pressurizes chamber E. Valve 270a remains in an open state, and valve 270b remains in a closed state. Thus, in gear 3 (ACE), chambers A, C, and E are pressurized from the high pressure fluid and chambers B, D, and F are unpressurized or at a low pressure. The net result in this gear is area A+area C+area E.

In one embodiment, when the hydraulic actuator 200 reaches the end of a stroke, in order to reverse direction, manifold 274a is changed from a high pressure line to a low pressure line and, conversely, manifold 274b is changed from a low pressure line to a high pressure line. This changeover can be achieved with, for example, a swash-plate-style pump, by taking the swash plate over center, or by using any other pump type with a simple shuttle valve or combination of larger two-way valves. Direction reversal is a common function of a closed loop hydraulic transmission. During the direction reversal all of the valves change state; that is, valves 270a and 270c are set to a closed state and valves 270b and 270d are set to an open state.

When actuating in direction 620, actuator 200 may also operate in three different gears. In reverse gear 1 (ABDEF) (shown in FIG. 8D), manifold 274b is the high pressure fluid supply and manifold 274a is the low pressure drain, Because there are no valves on manifold 274b, chambers B, D, and F are pressurized from the high pressure fluid. Valves 274b and 274d are in an open state, and valves 270a and 270c are in a closed state. Thus, in reverse gear 1 (ABDEF), chambers A, B, D, E, and F are pressurized from the high pressure fluid from manifold 274b, with chamber C being unpressurized or at a low pressure. Provided that the size and structure of the chambers, pistons, piston rod, and/or other components of the actuator 200 are such that the forces resulting from the pressurization of chambers A, B, E, and F cancel each other out (e.g., if the faces of the respective pistons all have an equivalent surface area on which the pressurized fluid acts), the net result in this gear is area D.

Starting from reverse gear 1 (ABDEF) (shown in FIG. 8E), reverse gear 2 (BDEF) is achieved by closing valve 270b and simultaneously (or with a timing offset) opening valve 270a. Valve 270c remains in a closed state and valve 270d remains in an open state. As a result, chamber A changes to an unpressurized or low pressure state while chamber B remains pressurized by the high pressure fluid from manifold 274b. Thus, in reverse gear 2 (BDEF), chambers B, D. E, and F are pressurized from the high pressure fluid and chambers A and C are unpressurized or at a low pressure. Provided that the size and structure of the chambers, pistons, piston rod, and/or other components of the actuator 200 are such that the forces resulting from the pressurization of chambers E and F cancel each other out (e.g., if the faces of the respective pistons all have an equivalent surface area on which the pressurized fluid acts), the net result in this gear is area B+area D.

Starting from reverse gear 2 (BDEF) (shown in FIG. 8F), reverse gear 3 (BDF) is achieved by setting valve 270d to a closed state and simultaneously (or with a timing offset) opening valve 270c. Valve 270a remains in an open state and valve 270b remains in a closed state. This causes chamber E to change to an unpressurized or low pressure state while maintaining chamber F at a pressurized state from the high pressure fluid from manifold 274b. Thus, in reverse gear 3 (BDF), chambers B, D, and F are pressurized from the high pressure fluid and chambers A, C, and D are unpressurized or at low pressure, The net result in this gear is area B+area D+area F.

Upon reaching the end of the reverse stroke, manifold 274a is switched back to a high pressure line, and manifold 274b is switched back to a low pressure line. The changeover can be achieved by, for example, taking a swash plate over center, During this reversal all of the valves change state; that is, valves 270a and 270c are set to a closed state and valves 270b and 270d are set to an open state.

As discussed above, embodiments of the hydraulic actuator described herein can be coupled at one or both ends to a piston in a separate housing, such as a working piston in a CAES system, Such a CAES system can utilize a plurality of hydraulic actuators, with each actuator coupled to at least one of a low-pressure and a high-pressure vessel arrangement to compress or expand a working gas, typically air. FIG. 9A and FIG. 9B show two different configurations for horizontally mounting the actuator in a CAES system (although other mounting configurations, such as vertical alignment, are possible). Referring to FIG. 9A, the actuator 900 drives a working piston in a CAES unit 920 at one end of the actuator 900. The working piston may be disposed on a shaft extending serially through a high pressure (HP) working vessel 922 and serially through a low pressure (LP) working vessel 924, each of which may have one or more pistons disposed within that are driven by or drive the actuator 900.

As shown in FIG. 9B, the shaft of the actuator 940 may be coupled at one end to a working piston in a housing of a first CAES unit 950, such as high pressure (HP) working vessel 952, and at the other end to a working piston in a housing of a second CAES unit 960, such as low pressure (LP) working vessel 962, thus positioning the actuator 940 substantially in the center of the two vessels 952, 962. Other configurations are possible; for example, an actuator may be coupled to one or more working vessels from one or more CAES units at one or both ends of the actuator.

The horizontal center mount of the hydraulic actuator 940 has a number of advantages over other configurations, particularly with respect to use of the actuator 940 in a horizontally-actuated CAES system, such as that described in the Horizontal CAES application.

In particular, the close proximity of the pressure chambers of the actuator 940 reduces the required length of pipes for the valving assembly and allows for a centralized valve manifold. Force is transmitted from and to both ends of the actuator shaft, thereby simplifying the end connections and, given the degree of freedom at each end connection, the alignment of process vessels to the hydraulic cylinders may be less precise. Further, assembly of the actuator 940 is simplified, and the actuator 940 may be shipped as a single unit to a worksite. The horizontal configuration also allows for servicing and component replacement without complete disassembly of the unit.

FIG. 10 illustrates an exemplary configuration of two hydraulic actuators 1010a, 1010b horizontally center-mounted in the modular CAES system 1000 described in the Horizontal CAES application. The primary components of the modular system 1000 are modular two-stage compression/expansion subassemblies 1020a, 1020b, each having two low pressure vessels 1030a-1030d respectively coupled to a low pressure hydraulic working vessel 1032a, 1032b, and two high pressure vessels 1040a-1040d respectively coupled to a high pressure hydraulic working vessel 1042a, 1042h. A reciprocating shaft having a working piston is disposed within each of the hydraulic working vessels 1032a, 1032b, 1042a, 1042b, and is driven by one of the two hydraulic actuators 1010a, 1010b. The compression/expansion subassemblies 1020a, 1020b can be identically structured, with one unit rotated 180 degrees with respect to the other. As such, each center-mounted hydraulic actuator 1020a, 1020b is coupled to the working piston in the low pressure working vessel of one unit and is coupled to the working piston in the high pressure working vessel of the other unit.

Certain embodiments of the present invention are described above. It is, however, expressly noted that the present invention is not limited to those embodiments, but rather the intention is that additions and modifications to what is expressly described herein are also included within the scope of the invention. For example, the cylinders, chambers, pistons, valves, and other components of the actuators described herein may be different in size, shape, configuration and number from the embodiments described and illustrated herein. Further, the components of the actuator need not have uniform properties; for example, the inner and/or outer diameters of pistons, piston rods, and/or cylinders may vary among individual components, resulting, e.g., in different piston surface areas upon which pressurized fluid can act, and thereby resulting in more, fewer, or different possible gears or actuation forces. Other arrangements of the piping, manifolds, and valves are possible as well. It is to be appreciated that the teachings in this application can be applied to various other actuator embodiments to provide a greater number of actuator gears than valves. Further the principles of the invention can be applied to pneumatic actuators and other actuators that use liquids, aerosols, gases or other compressible or incompressible fluids for operation.

Moreover, it is to be understood that the features of the various embodiments described herein are not mutually exclusive and can exist in various combinations and permutations, even if such combinations or permutations are not made express herein, without departing from the spirit and scope of the invention. In fact, variations, modifications, and other implementations of what is described herein will occur to those of ordinary skill in the art without departing from the spirit and the scope of the invention. As such, the invention is not to be defined only by the preceding illustrative description, but rather by the claims, and all equivalents.

1. A hydraulic actuator adapted to be coupled to a piston of a compressed air energy storage (CAES) system, the actuator comprising:
a housing forming three aligned bores; and
a shaft disposed in the housing for reciprocating movement, the shaft comprising three pistons disposed in the three bores, thereby dividing the three bores into a plurality of pressure chambers,
wherein the shaft is moveable relative to the housing by pressurizing at least one of the pressure chambers with hydraulic fluid.

2. The actuator of claim 1, wherein the housing comprises:
a plurality of cylinders forming the bores; and
corresponding dividers disposed between the cylinders.

3. The actuator of claim 2, wherein the pistons and the dividers form six pressure chambers.

4. The actuator of claim 3, wherein the actuator comprises no more than six pressure chambers.

5. The actuator of claim 2, wherein the dividers form a fluidic seal with the shaft.

6. The actuator of claim 2, wherein the housing comprises no more than two dividers.

7. The actuator of claim 1, wherein the shaft further comprises a rod, and wherein the pistons are at least one of attached to the rod and forged on the rod.

8. The actuator of claim 7, wherein the rod comprises a varying outer diameter,

9. The actuator of claim 1, wherein the shaft comprises no more than three pistons.

10. The actuator of claim 1, wherein at least two of the bores have different inner diameters.

11. The actuator of claim 10, wherein at least two of the pistons have different outer diameters.

12. The actuator of claim 1 further comprising a plurality of fluidic valves fluidically coupled to the pressure chambers.

13. The actuator of claim 12, wherein the valves are adapted to be independently operable to pressurize a combination of the pressure chambers to control direction of movement and force of the shaft.

14. The actuator of claim 13, wherein the plurality of valves comprise four valves to pressurize selectively six pressure chambers.

15. The actuator of claim 14, the actuator comprises no more than four valves.

16. The actuator of claim 1, wherein the shaft is adapted to be coupled at at least one of a proximal end and a distal end thereof to the CAES piston disposed in a separate housing.

17. The actuator of claim 16, wherein the shaft is adapted to be coupled at the proximal end to a first CAES piston disposed in a first separate housing and at the distal end to a second CAES piston disposed in a second separate housing.

18. A method for operating a hydraulic actuator, the method comprising:
providing a hydraulic actuator, the actuator comprising:
a housing forming three aligned bores; and
a shaft disposed in the housing for reciprocating movement, the shaft comprising three pistons disposed in the three bores, thereby dividing the three bores into a plurality of pressure chambers; and
moving the shaft relative to the housing by pressurizing at least one of the pressure chambers with hydraulic fluid.

19. The method of claim 18, wherein the housing comprises:
a plurality of cylinders forming the bores; and
corresponding dividers disposed between the cylinders.

20. The method of claim 19, wherein the pistons and the dividers form six pressure chambers.

21. The method of claim 20, wherein the actuator comprises no more than six pressure chambers.

22. The method of claim 19, wherein the dividers form a fluidic seal with the shaft.

23. The method of claim 19, wherein the housing comprises no more than two dividers.

24. The method of claim 18, wherein the shaft comprises no more than three pistons.

25. The method of claim 18, wherein the actuator further comprises a plurality of fluidic valves fluidically coupled to the pressure chambers.

26. The method of claim 25, further comprising independently operating at least one of the valves to pressurize a combination of the pressure chambers to control direction of movement and force of the shaft,

27. The method of claim 26, wherein the plurality of valves comprise four valves to pressurize selectively six pressure chambers.

28. The method of claim 27, wherein the actuator comprises no more than four valves.

29. The method of claim 18, further comprising coupling the shaft at at least one of a proximal end and a distal end thereof to a piston of a CAES system disposed in a separate housing.

30. The method of claim 29, further comprising coupling the shaft at the proximal end to a first piston of a CAES system disposed in a first separate housing and at the distal end to a second piston of a CAES system disposed in a second separate housing.
